(19) United States
(12) Patent Application Publication
(10) Pub. No.: US 2018/0143312 A1
(43) Pub. Date: May 24, 2018

(54) SYSTEM AND METHOD FOR ULTRA WIDEBAND SIGNAL USAGE WITH AUTONOMOUS VEHICLES IN BUILDINGS

(71) Applicant: Wal-Mart Stores, Inc., Bentonville, AR (US)

(72) Inventors: Donald R. High, Noel, MO (US); David C. Cox, Rogers, AR (US); John J. O'Brien, Farmington, AR (US)

(21) Appl. No.: 15/812,637

(22) Filed: Nov. 14, 2017

Related U.S. Application Data
(60) Provisional application No. 62/424,615, filed on Nov. 21, 2016.

(51) Int. Cl. G01S 13/02; G05D 1/00; G05D 1/02; H04W 4/04; G01C 21/20

(52) U.S. Cl. CPC G01S 13/0209; G05D 1/0088; G05D 2201/0207; H04W 4/046; G01C 21/206; G05D 1/0214

(57) ABSTRACT

A product distribution system in a building includes an unmanned vehicle and a control circuit in the unmanned vehicle. The unmanned vehicle operates independently within the building. The unmanned vehicle is configured to transmit and receive first ultra wideband (UWB) signals. The control circuit is configured to determine the position of the unmanned vehicle based upon an analysis of at least some of the first UWB signals, and to navigate the unmanned vehicle according to the position. The unmanned vehicle is configured to transmit second UWB signals to a device operating within the building, and responsively receive third UWB signals from the device. Based upon the analyzing of the third UWB signals, the control circuit determines a position of the device to avoid a collision between the unmanned vehicle and the device.

### CROSS-REFERENCE TO RELATED APPLICATION

This application claims the benefit of the following U.S. Provisional Application No. 62/424,615 filed Nov. 21, 2016, which is incorporated herein by reference in its entirety.

### TECHNICAL FIELD

This invention relates generally to ultra wideband (UWB) signal usage at vehicles, and more particularly, to utilizing UWB signals with autonomous vehicles.

### BACKGROUND

Current navigation systems are limited by their accuracy in geo-location positioning and tracking, which is problematic for unmanned autonomous aerial vehicles and autonomous ground vehicles. More specifically, current navigation systems generally provide accurate feedback within only a few meters. This can be a problem for autonomous vehicles such as drones that operate within crowded buildings where more precise location determination is often needed so that the drones can be tracked and so that the drones can navigate.

Additionally, signal interference is problematic for current systems in usage today. In fact, many current navigational systems lose signal when an object or a mode of interference is present. This is particularly a problem in buildings, which are often crowded with various types of objects.

Additionally, the high power consumption of devices employing traditional technologies is a problem, in particular, for aerial autonomous vehicles such as drones. Drones need to conserve power and the improper navigation of the vehicles can consume large amounts of power.

All of these problems have led to some user dissatisfaction with current approaches.

### BRIEF DESCRIPTION OF THE DRAWINGS

Disclosed herein are embodiments of systems, apparatuses and methods pertaining to utilizing UWB signals with autonomous vehicles in buildings. This description includes drawings, wherein:

FIG. 1 is a block diagram showing a building that has devices operating therein using UWB signals in accordance with some embodiments;

FIG. 2 is a flowchart showing the operation of an unmanned vehicle in accordance with some embodiments;

FIG. 3 is a block diagram of an unmanned autonomous aerial vehicle in accordance with some embodiments;

FIG. 4 is a block diagram of a system using UWB signals with smart devices in accordance with some embodiments;

FIG. 5 is a block diagram showing a system that avoids collisions using UWB signals in accordance with some embodiments;

FIG. 6 is a diagram of a multi-layered system using different technologies to navigate to different areas in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, systems, apparatuses and methods are provided that utilize Ultra-Wideband Technology (UWB) communication approaches within buildings (e.g., warehouses) and/or exterior spaces. UWB technology may be deployed at various elements within these systems or networks such as at unmanned aerial vehicles (UAVs), automated ground vehicles (AGVs), or at fixed locations. To mention a few exemplary examples, UWB approaches can be used in the tracking (and precise location determination) of vehicles (in motion or at rest) or objects (such as consumer products), in communications between devices, in collision avoidance techniques (e.g., between moving vehicles and stationary objects), and in surveillance. Other examples are possible. Advantageously, UWB signals transmit high amounts of data across a broad spectrum at extremely high speeds without interference from narrowband communications systems and with very low power consumption.

As mentioned, the present approaches provide accurate positioning of and navigation of unmanned aerial vehicles, as well as autonomous ground vehicles. For instance, tracking is provided while navigating throughout the open exterior spaces, and/or within enclosed areas or spaces (e.g., within a building such as a warehouse). In one aspect, UWB approaches provide tracking services that ascertain an object's location with a resolution of centimeters or less. Advantageously, UWB tracking services require lower amounts of power consumption compared to many other previous approaches.

UWB technology has the ability to carry signals through obstacles, such as doors, walls, buildings, and other objects with little or no interference from these objects. Consequently, the approaches described herein are especially useful in enclosed and crowded spaces that store objects such as warehouses or the like.

UWB technology can be utilized and deployed at a wide variety of different devices. For example, UWB technology can be deployed with autonomous devices (e.g., unmanned aerial vehicles, autonomous ground vehicles, and autonomous vending devices), ordinary vehicles (cars, trucks), control centers, central computers, warehouse equipment (e.g., forklifts, cherry pickers), handheld scanners, and smart devices. Other examples are possible.

As described herein, UWB communications technology (sometimes referred to as Pulse Radio) is an approach for transmitting and receiving signals in short-ranges, but uses a high-bandwidth of communication over a radio spectrum (>500 MHz). UWB does not interfere with conventional narrowband and carrier wave transmissions operating in the same frequency band. UWB is typically an antenna transmission where the transmitted bandwidth signal in some aspects exceeds the lesser of 500 MHz, or 20% of fractional bandwidth.

Because each pulse in a pulse-based UWB occupies an entire UWB bandwidth, it benefits from relative immunity from multipath fading, but not from inter-symbol interference (ISI). ISI is a form of distortion of a signal in which one symbol interferes with subsequent symbols. Multipath interference is a phenomenon in physics where waves interfere with each other, resulting in a phase shift.

UWB pulses are generated with definitive time modulation, allowing for the information received to be analyzed with the time the signal was dispatched. This enables a pulse-position or time modulation. The UWB signal is then modulated by encoding the polarity of the pulse and its amplitude, or by utilizing orthogonal pulses. Because of UWB's ability to integrate time modulation into the signal, time-of-flight can be determined and this assists in overcoming multipath propagation.

UWB technology can be used in autonomous vehicles for collision and obstacle avoidance, for example, sensing the presence of an object and avoiding a collision with that object.

In some embodiments, the present approaches also allow UWB technology to be used as a surveillance system. For example, UWB signals may act as a security fence by establishing a RF perimeter field and detecting intrusion of objects within the field. This can be applied to the intrusion of aircraft and vehicles, to mention a few examples. Surveillance shields can function as a cloud for navigation, also detecting any movement by any object or device within the field.

UWB technology can be deployed in tags/identifiers for intelligent transportation systems, for example, by placing RFID tags in vehicles and tracking vehicle location.

UWB technology can also be used with radio tags to determine and track product or asset location, for example, within a warehouse, vehicle (e.g., truck) or a store. More specifically, UWB technology can be used together with RFID tagging and identification applications. For instance, RFID tags can be used to wirelessly identify objects, individuals and devices using UWB signals. In aspects, a coded transmitter, such as an RFID chip, can be coupled or applied to an asset or product for simultaneous inventory management. This provides the ability to determine the presence of an object (with its exact location) to track its movement.

UWB technology can also be applied to network communications such as those associated with wireless personal area networks (WPANs). UWB communications may replace existing cables for portable devices (e.g., camcorders, digital cameras, MP3 players, and smart devices). UWB communications enable high-speed wireless universal serial bus (WUSB) connectivity for PCs and PC peripherals; such as printers, scanners, and external storage devices.

In some of these embodiments, a product distribution system in a building includes an unmanned vehicle and a control circuit in the unmanned vehicle. The unmanned vehicle operates independently within the building. The building has products disposed therein, and the unmanned vehicle is configured to transmit and receive first UWB signals. The control circuit is configured to determine the position of the unmanned vehicle based upon an analysis of at least some of the first UWB signals, and to navigate the unmanned vehicle according to the position. The unmanned vehicle is configured to transmit second UWB signals to a device operating within the building, and responsively receive third UWB signals from the device. The control circuit is configured to analyze the third UWB signals received from the device, and based upon analyzing of the third UWB signals, determine a position of the device to avoid a collision between the unmanned vehicle and the device.

In some aspects, a radio tag is disposed within the building, and the tag is coupled to a product. The unmanned vehicle is configured to receive a response signal from the tag after the tag is activated by fourth UWB signals transmitted by the unmanned vehicle, and the response signal includes information associated with the product coupled to the tag. In some examples, the response signal from tag is a UWB signal.

In other aspects, a second unmanned vehicle is configured to transmit UWB signals while operating outside the building. In some examples, the second unmanned vehicle is navigated to within a predetermined radius or distance of a target location without using UWB signaling, and then navigated within the radius or distance of the target location using UWB signaling.

In other examples, the unmanned vehicle is an unmanned aerial vehicle or a ground based unmanned vehicle. In yet other examples, the device is a portable electronic device, an unmanned aerial vehicle, an unmanned ground vehicle, or a stationary object. The building may be utilized for a wide variety of purposes. For example, the building may be a warehouse, a retail store, or an office. Other examples are possible.

In yet other examples, the control circuit is configured to determine the height of the unmanned vehicle by analyzing the first UWB signals. The first UWB signals may be analyzed for other purposes as well.

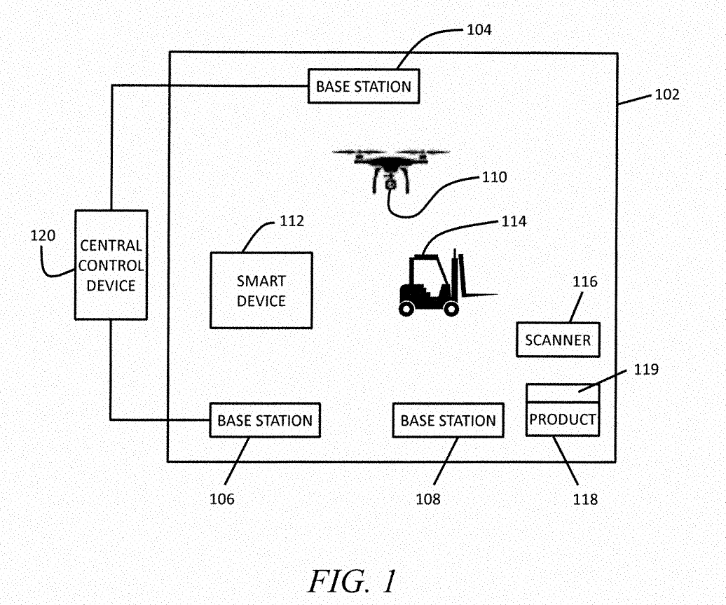

Referring now to FIG. 1, one example of a building 102 having devices that operate utilizing UWB technology is described. Within the building 102 are base stations 104, 106, and 108, an unmanned autonomous aerial vehicle (in some embodiments, a drone) 110, a smart device 112, a ground vehicle 114, a scanner 116, a product 118 with tag 119, and a central control device 120.

The base stations 104, 106, and 108 may transmit and receive various types of signals including UWB signals. The unmanned autonomous aerial vehicle 110 may transmit and receive UWB signals to determine its position and navigate through the building 102 according to this position. The unmanned autonomous aerial vehicle 110 may control its own movement independently from any central control center or device. The smart device 112 is any portable electronic device such as a cellular phone or a tablet. The smart device 102 may transmit and/or receive UWB signals and/or normal wireless communication signals.

The ground vehicle 114 may be any type of ground vehicle, and may be manned or unmanned. The ground vehicle 114 may be autonomous and control its own movement (independently from any central control center or device), or it may be manually controlled (e.g., by a human operator driving the vehicle). The ground vehicle 114 may transmit and/or receive UWB signals and utilize these signals to determine its position and navigate through the building 102.

The scanner 116 is used to activate the tag 119 and receive information from the tag. In one example, UWB signals transmitted from the scanner 116 are used to activate the tag 119, the tag 119 responds with signals (including information concerning the object that the tag is attached), and the scanner 116 receives the signals (that may be in the form of UWB signals). The scanner 119 is shown as being a portable device external to any of the vehicles. However, it will be appreciated that the scanner can also be deployed at the unmanned autonomous aerial vehicle 110 or the ground vehicle 114.

The product 118 is any type of product stored in the building and may, in some examples, be a consumer product or other product intended for sale. In other examples, the product 118 may be a box or crate of individual products.

The tag 119, in some examples, is a radio frequency identification (RFID) tag. The tag 119 may be activated by an incident signal and upon activation transmit information concerning the product (e.g., product number or product type to mention two examples) to the scanner 116. In other examples, the tag 119 may transmit independently without the need for external activation. UWB signals may be used to activate the tag 119, and the tag 119 may transmit information back to the scanner 116 using UWB signals.

The central control device 120 may be coupled to the various base stations or other devices. The central control device 120 may track and display the position of the devices within the building 102. For example, the central control device 120 is coupled to the base stations 104, 106, 108 and may use information from the base stations to create a map showing the position of various devices within the building 102. The map may be rendered to a user at a display screen at the central control device 120. The map may be updated in real time to reflect the changing positions of the devices within the building 102. The central control device 120 may be coupled to the base stations 104, 106, 108 in a wired connection, but in other examples the connection may be made using UWB signals.

It will be appreciated that all the devices in FIG. 1 (base stations 104, 106, and 108, unmanned autonomous aerial vehicle 110, smart device 112, ground vehicle 114, scanner 116, tag 119, and central control device 120) may transmit and/or receive UWB signals. These devices may also utilize other communication signals (e.g., the smart device 112 may also use signals typically used for wireless communications).

The various devices can also serve as repeaters that receive a UWB signal and that transmit the UWB signal (at an increased signal strength). For example a first unmanned autonomous aerial vehicle may transmit a UWB signal to a second unmanned autonomous aerial vehicle. The signal may be repeated with increased signal strength and transmitted from the second unmanned autonomous aerial vehicle to a base station. New information (from the second unmanned autonomous aerial vehicle) may be included within the repeated signal that is sent to the base station.

In one example of the operation of the unmanned autonomous aerial vehicle 110, the unmanned autonomous aerial vehicle 110 operates independently within the building 102. The building 102 has products (e.g., product 118) disposed therein, and the unmanned autonomous aerial vehicle 110 is configured to transmit and receive UWB signals. The unmanned autonomous aerial vehicle 110 determines its position using transmitted and/or received UWB signals, and navigates within the building 102 to this position. The position may be absolute geographic coordinates, or may be relative coordinates within a particular building. For instance, knowing its position (and information concerning building layout and the position of objects or devices within the building 102) the unmanned autonomous aerial vehicle 110 can turn at appropriate times, vary its speed at various times, or vary its height at various times. Other navigational actions are possible.

In one example, the base stations 104, 106, and 108 may transmit UWB signals that are received by the unmanned autonomous aerial vehicle 110. These UWB signals may include time information, which is processed by the unmanned autonomous aerial vehicle 110. Time of arrival (TOA) approaches may be used to determine the position of the unmanned autonomous aerial vehicle 110 and then the determined position is used in navigating the unmanned autonomous aerial vehicle 110 within the building 102.

In another example, the unmanned autonomous aerial vehicle 110 may transmit UWB signals to the base stations 104, 106, and 108. The base stations 104, 106, and 108 may receive the UWB signals and use triangulation approaches to determine the position of the unmanned autonomous aerial vehicle 110. This position can then be communicated to the unmanned autonomous aerial vehicle 110 (e.g., using UWB signals) and used in navigating the unmanned autonomous aerial vehicle 110 within the building 102.

The unmanned autonomous aerial vehicle 110 is also configured to transmit UWB signals to a device operating within the building, and responsively receive UWB signals from the device. The unmanned autonomous aerial vehicle 110 is configured to analyze the UWB signals received from the device, and based upon the analyzing of the UWB signals, determine a position of the device to avoid a collision between the unmanned autonomous aerial vehicle 110 and the device. For example, the unmanned autonomous aerial vehicle 110 may transmit UWB signals and reflected signals are returned and analyzed to determine the position of the device.

In another example, the unmanned autonomous aerial vehicle 110 transmits UWB signals to the device and the device transmits UWB back to the vehicle 110 that identify the device and its position. This information is used by the unmanned autonomous aerial vehicle 110 to navigate the unmanned autonomous aerial vehicle 110 and avoid a collision with the device.

In still other examples, the unmanned autonomous aerial vehicle 110 may receive information from the base stations 104, 106, or 108 (e.g., using UWB signals) reporting locations of obstacles and the unmanned autonomous aerial vehicle 110 may use this information to navigate to avoid these obstacles.

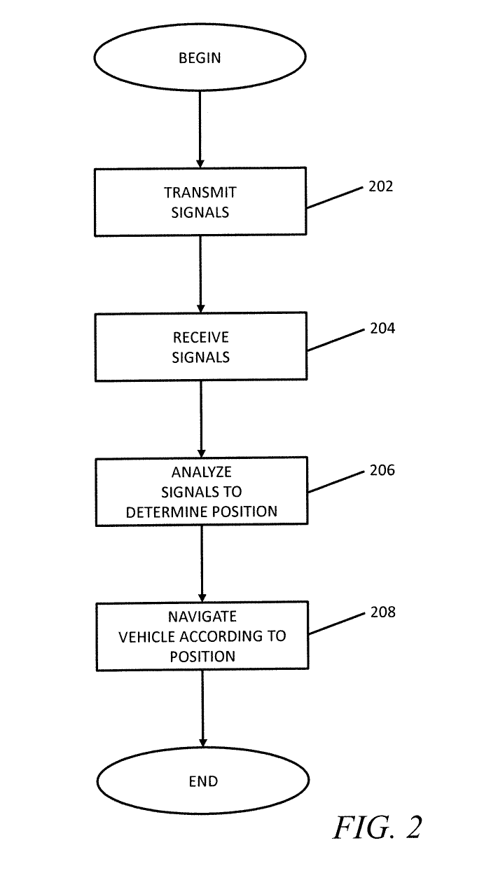

Referring now to FIG. 2, one example of an approach of operating an unmanned autonomous aerial vehicle using UWB signals is described. At step 202, UWB signals are transmitted from the unmanned vehicle. Step 202 may be an optional step and in some examples, may be omitted. At step 204, signals are received at the unmanned autonomous aerial vehicle. If signals were transmitted at step 202, these signals may be reflected signals. If step 202 is omitted, the received signals may be beacon signals from base stations. In other examples, the signals may be transmitted by base stations and include information concerning potential obstacles for the unmanned autonomous aerial vehicle to avoid.

At step 206, the signals are analyzed to determine the position of the unmanned autonomous aerial vehicle. For example, TOA processing approaches (well known to those skilled in the art) may be used to process signals from base stations and to determine a distance to the base stations (and thus, the position of the unmanned autonomous aerial vehicle). If the signal is a reflected signal, other well-known processing techniques can be used to determine the distance and direction to the obstacle (and hence its position).

At step 210, the position information determined at step 206 is used to navigate the unmanned vehicle. For example, the unmanned vehicle now knowing its correct position can navigate to a target location or desired location within the building. In another example, the unmanned vehicle knowing its location can navigate to avoid obstacles with known positions.

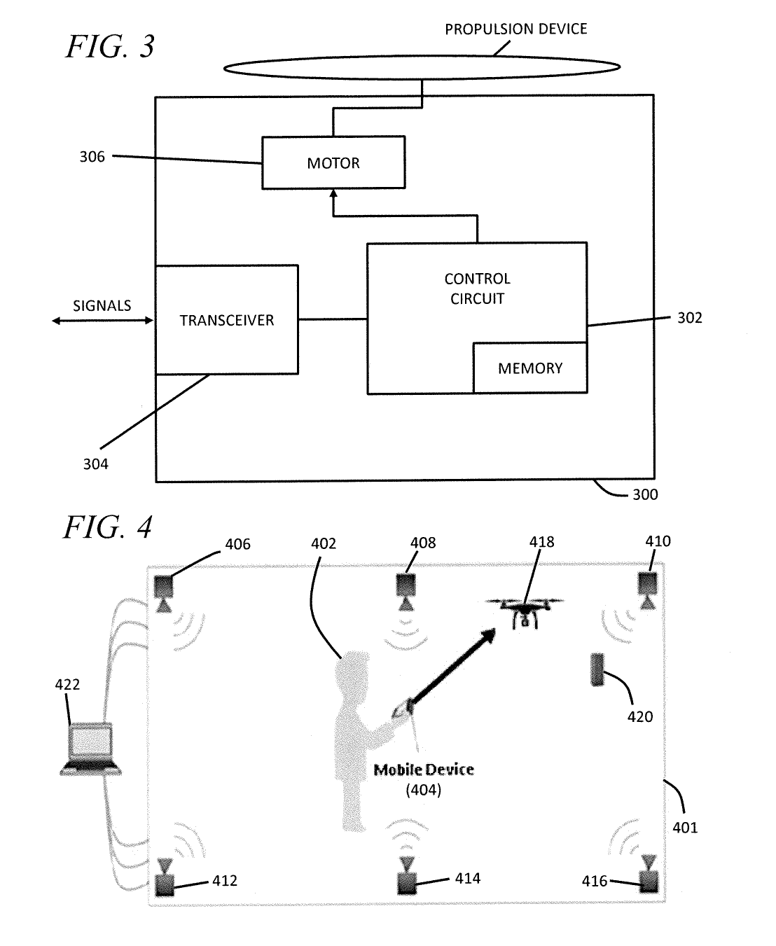

Referring now to FIG. 3, an unmanned vehicle 300 includes a control circuit 302, a transceiver 304, and a motor (or engine) 306, which couples to a propulsion device 308. The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 302 may be configured (for example, by using corresponding programming stored in a memory as will be well understood by those skilled in the art) to carry out one or more of the steps, actions, and/or functions described herein.

The transceiver 304 is configured to transmit and/or receive UWB signals. It may include, for example, one or more antennas and any interface circuitry to convert UWB signals into digital signals (and vice versa).

The motor (or engine) 306 is any type of device used to generate mechanical energy to move the vehicle 300. The propulsion device 308 is any device used to propel the device (e.g., a propeller or rotary blades when the vehicle 300 is an aerial drone).

In one example of the operation of the unmanned vehicle 300, the vehicle 300 operates independently within a building. The building has products disposed therein, and the unmanned vehicle 300 is configured to transmit and/or receive UWB signals via the transceiver 304. The control circuit 302 determines the position of the unmanned vehicle 300 based upon an analysis of at least some of the UWB signals, and to navigate the unmanned vehicle 300 according to the position.

In some examples, UWB signals from base stations may be received at the transceiver 304. These signals may be processed (e.g., using well-known TOA processing approaches) by the control circuit 302 to determine a location of the unmanned vehicle 300. In another example, the control circuit 302 may transmit signals to base stations via the transceiver 304. The base stations may use various approaches (e.g., triangulation) to determine the position of the unmanned vehicle 300 and this position may be reported to the unmanned vehicle in UWB signals sent by the base station. In all cases, the determined position may be used to navigate the vehicle, for example, within a building or a portion of a building (e.g., a room).

The unmanned vehicle 300 is also configured to transmit UWB signals to a device operating within the building, and responsively receive UWB signals (or possibly other types of signals) from the device. The control circuit is configured to analyze the UWB signals received from the device, and based upon the analyzing of the UWB signals, determine a position of the device to avoid a collision between the unmanned vehicle and the device. For example, the transceiver 304 may transmit UWB signals and reflected signals are returned and processed by the control circuit 302 to determine the position of the device.

In another example, the transceiver 304 transmits UWB signals to the device and the device transmits UWB signals back to the transceiver 304, and the control circuit 302 processes these signals to determine the position of the device.

In still other examples, the unmanned vehicle 300 may receive information from the base stations reporting locations of obstacles and the vehicle 300 may use this information to navigate to avoid these obstacles. For example, the transceiver 304 may receive this information, and the control circuit 302 may process this information to obtain the position of the device.

Referring now to FIG. 4, one example of an approach that uses UWB signals with smart devices is described. The example of FIG. 4 shows the room 401 of a building. A human 402 has a smart device 404. The smart device 404 may be any type of smart electronics device such as a cellular phone or tablet. Base stations 406, 408, 410, 412, 414, and 416 may transmit and/or receive UWB signals. An unmanned autonomous aerial vehicle 418 operates within the building. A locker 420 is also positioned within the building.

The base stations 406, 408, 410, 412, 414, and 416 may transmit UWB signals (or other types of signals) to the smart device 404 reporting the positions, for example, of the unmanned autonomous aerial vehicle 418 (at 2 meters and at 2 o'clock position) relative to the smart device 418.

In other aspects, the smart device 404 includes a UWB transceiver that transmits UWB signals to the base stations 406, 408, 410, 412, 414, and 416. The base stations 406, 408, 410, 412, 414, and 416 connect to a wider network (and to a control device 422), and either the network or the control device 422 store information concerning the position of objects and devices within the room (e.g., position of the locker 420). This information can be communicated by UWB signals (or possibly other types of signals such as cellular signals) to the smart device 404. In this way, the smart device 404 can access a wide variety of information that can be used by the human 402 to navigate to a target location or avoid a collision with an object.

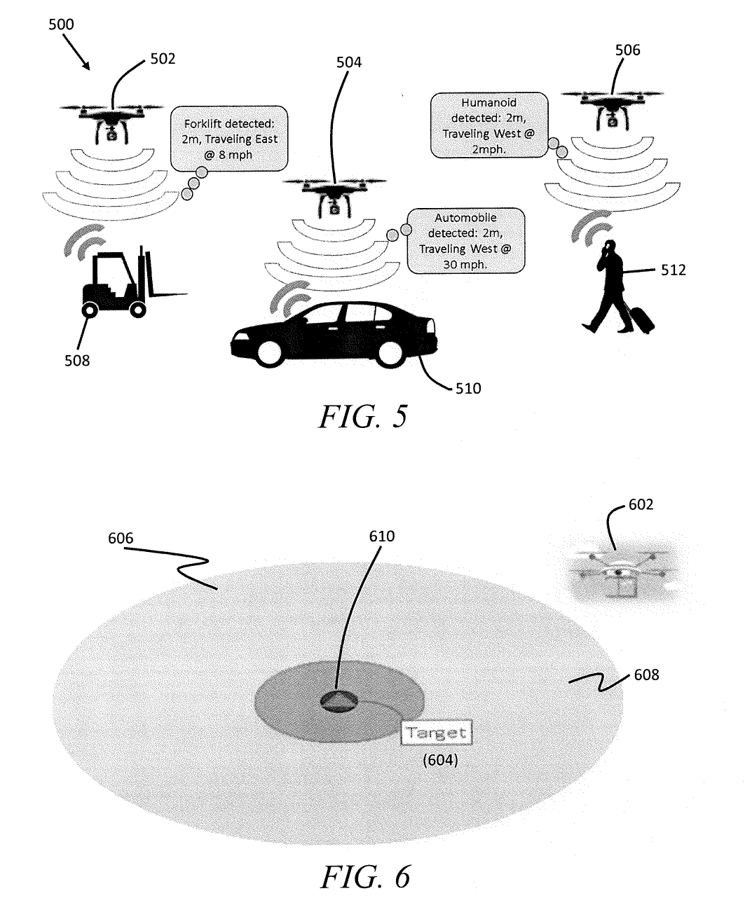

Referring now to FIG. 5, one example of a system that avoids collisions using UWB signals is described. The system 500 includes unmanned autonomous aerial vehicles (drones) 502, 504 and 506, a forklift 508, a vehicle 510, and a human 512 (with a smart device). It will be appreciated that unique challenges exist in an interior setting. For example, in an interior certain signals (e.g., GPS) may not be received, there are many moving components (e.g., humans and drones), interfering and reflecting sources are constantly changing, and objects do not necessarily move about defined paths in the space. Advantageously, the present approaches provide short range communications in these spaces that solve these and other problems.

The unmanned autonomous aerial vehicles 502, 504 and 506 are autonomous vehicles that control their movement independently from a central control. The vehicles 502, 504 and 506 include transceivers that transmit and/or receive UWB signals.

The forklift 508 may include a device (e.g., a tag or a transceiver) that transmits and/or receives UWB signals. The forklift may be autonomous or, in other examples, be operated by a human. The vehicle 510 may be a car or a truck in examples and may include a device (e.g., a tag or a transceiver) that transmits and/or receives UWB signals. The human 512 may have a smart device (e.g., a cellular phone or a tablet) that transmits and receives UWB signals.

In operation, the vehicles 502, 504 and 506 transmit and/or receive UWB signals that are used to avoid collisions between the vehicles 502, 504 and 506 and objects such as forklift 508, the vehicle 510, or the human 512.

For example, the vehicles 502, 504 and 506 may transmit UWB signals and reflected signals are returned and processed by the vehicles 502, 504 and 506 to determine the position of the object. In another example, the vehicles 502, 504 and 506 transmit UWB signals to a device (e.g., smart device) or object (RFID tag associated with a product) and the device transmits UWB signals to the vehicles 502, 504 and 506, which process these signals to determine the position of the device. In still other examples, the vehicles 502, 504 and 506 may receive information from the base stations reporting locations of obstacles and the vehicles 502, 504 and 506 may use this information to navigate to avoid these obstacles.

Referring now to FIG. 6, one example of a multi-layered system where UWB signals are used for navigation purposes in some areas, while other technologies are used in other areas is described. An unmanned autonomous vehicle 602 navigates to a target 604. A first layer 606 surrounds a second layer 608, which surrounds a third layer 610. A first technology may be used to determine position and navigate in the first layer 606, a second technology may be used within the second layer 608, and a third technology within the third layer 610.

In one example, the first and second layers are outside a building, while the third layer is within the building. Global positioning satellite (GPS) technology may be used to determine position and navigate in the first layer 606, Bluetooth technology in the second layer 608, and UWB technology in the third layer 610. As the vehicle 602 passes between layers, a technology handoff occurs where the vehicle 602 switches between the technology used to determine its location and navigate the vehicle 602.

In another example, the third layer extends a distance less than 1 cm from the target 604; the second layer is between 1 cm and 1 meter from the target 604; and the third layer is greater than 1 meter from the target 604. In aspects, GPS technology can be used for navigation and position determination purposes in the first layer, Bluetooth technology in the second layer, and UWB technology in the third layer. In this example, all layers may be within a building (or in another example, outside a building).

It will be appreciated that FIG. 6 shows one example of a multi-layered positioning and navigation approach, and that the number of layers, the dimensions of layers, and the technology deployed to navigate within any given layer may vary. The layers are also shown as being circular. However, it will be appreciated that these layers can take on any shape (e.g., any type of polygon).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product distribution system in a building, comprising:
an unmanned vehicle operating independently within the building, the building having products disposed therein, the unmanned vehicle being configured to transmit and receive first ultra wideband (UWB) signals;
a control circuit disposed at the unmanned vehicle and that is configured to determine the position of the unmanned vehicle based upon an analysis of at least some of the first UWB signals, and to navigate the unmanned vehicle according to the position;
a radio tag being coupled to a product in the building;
wherein the unmanned vehicle is configured to transmit second UWB signals to a device operating within the building, and responsively receive third UWB signals from the device, and wherein the control circuit is configured to analyze the third UWB signals received from the device, and based upon the analyzing of the third UWB signals, determine a position of the device to avoid a collision between the unmanned vehicle and the device;
wherein the unmanned vehicle is configured to receive a response signal from the tag after the tag is activated by fourth UWB signals transmitted by the unmanned vehicle, the response signal including information associated with the product coupled to the tag;
wherein the unmanned vehicle is navigated to within a predetermined radius of a target location within the building without using UWB signaling, and then is navigated within the radius of the target location using UWB signaling according to the position of the unmanned vehicle determined by the control circuit.

2. The system of claim 1, wherein the response signal from tag is a UWB signal.

3. The system of claim 1, wherein the unmanned vehicle is navigated to within a predetermined radius of a target location within the building using GPS technology.

4. The system of claim 1, wherein the unmanned vehicle is an unmanned aerial vehicle or a ground based unmanned vehicle.

5. The system of claim 1, wherein the device is a portable electronic device, an unmanned aerial vehicle, an unmanned ground vehicle, or a stationary object.

6. The system of claim 1, wherein the building is a warehouse, a retail store, or an office.

7. The system of claim 1, wherein the control circuit is configured to determine the height of the unmanned vehicle by analyzing the first UWB signals.

8. A method of operating vehicles in a building, the method comprising:
transmitting and receiving first ultra wideband (UWB) signals at a first unmanned vehicle that operates independently within the building, the building having products disposed therein;
determining the position of the unmanned vehicle based upon an analysis of at least some of the first UWB signals, and navigating the unmanned vehicle according to the position;
transmitting second UWB signals to a device operating within the building, and responsively receiving third UWB signals from the device;
analyzing the third UWB signals received from the device, and based upon the analyzing of the third UWB signals, determining a position of the device to avoid a collision between the unmanned vehicle and the device;
wherein a radio tag disposed within the building, the tag being coupled to a product, and further comprising receiving a response signal from the tag after the tag is activated by fourth UWB signals transmitted by the unmanned vehicle, the response signal including information associated with the product coupled to the tag;
wherein the unmanned vehicle is navigated to within a predetermined radius of a target location within the building without using UWB signaling, and then navigated within the radius of the target location using UWB signaling according to the determined position of the unmanned vehicle.

9. The method of claim 8, wherein the response signal from tag is a UWB signal.

10. The method of claim 8, wherein the unmanned vehicle is an unmanned aerial vehicle or a ground based unmanned vehicle.

11. The method of claim 8, wherein the unmanned vehicle is navigated to within a predetermined radius of a target location within the building using GPS technology.

12. The method of claim 8, wherein the device is a portable electronic device, an unmanned aerial vehicle, an unmanned ground vehicle, or a stationary object.

13. The method of claim 8, wherein the building is a warehouse, a retail store, or an office.

14. The method of claim 8, further comprising determining the height of the unmanned vehicle by analyzing the first UWB signals.
